(19) United States
(12) Patent Application Publication
(10) Pub. No.: US 2026/0136053 A1
(43) Pub. Date: May 14, 2026

(54) PERSONALIZED ADVERTISING BREAK CONTENT GENERATION AND DELIVERY

(71) Applicant: DISH Network Technologies India Private Limited, Bengaluru (IN)

(72) Inventor: Bharani Vittal Gopinath, Bangalore (IN)

(21) Appl. No.: 19/016,005

(22) Filed: Jan. 10, 2025

(30) Foreign Application Priority Data
Nov. 14, 2024 (IN) 202441088201

(51) Int. Cl. H04N 21/25; H04N 21/234; H04N 21/442; H04N 21/81

(52) U.S. Cl. CPC H04N 21/252; H04N 21/23424; H04N 21/44204; H04N 21/812

(57) ABSTRACT

Techniques for personalizing advertising break content are provided. In one example, an Internet Protocol Television (IPTV) provider server system receives a common interest shared by a plurality of viewers and generates affinity content related to the common interest. In response to a request from an IPTV client application associated with a user account maintained by the IPTV server system, the IPTV server system transmits a stream of primary media content to the client application that includes at least one advertising break. Based on a viewing history of the user account, the IPTV server system determines that a viewer associated with the user account is interested in the common interest and inserts the affinity content into the stream during a portion of the at least one advertising break.

### CROSS REFERENCE TO RELATED APPLICATIONS

This application claims priority to Indian Provisional Patent Application No. 202441088201, filed on Nov. 14, 2024, the disclosure of which is incorporated by reference in its entirety for all purposes.

### BACKGROUND OF THE INVENTION

Internet Protocol Television (IPTV) and traditional broadcast television have long relied on advertising breaks to generate revenue and support content distribution. In traditional broadcasting, advertising breaks are pre-scheduled intervals within a program where advertisements are inserted, often resulting in a uniform viewing experience regardless of individual viewer preferences. This one-size-fits-all approach can lead to viewer disengagement, particularly when the ads are not relevant to the audience. IPTV, while offering more flexibility in content delivery and personalization, often faces similar challenges. Despite the potential for targeted advertising, IPTV providers may struggle to fill all available advertising slots due to insufficient ad inventory or mismatched targeting criteria. Both traditional and IPTV systems can suffer from viewer frustration and reduced engagement during advertising breaks, highlighting the need for more innovative solutions to maintain audience engagement.

### BRIEF SUMMARY OF THE INVENTION

In some embodiments, a method of personalizing advertising break content is provided. The method may include receiving, by an Internet Protocol Television (IPTV) provider server system, a common interest shared by a plurality of viewers. The method may further include generating, by the IPTV provider server system, affinity content related to the common interest. The method may further include receiving, by the IPTV provider server system, a request from an IPTV client application for a stream of primary media content, wherein the stream will include at least one advertising break in the primary media content, and wherein the request is associated with a user account maintained by the IPTV provider server system. The method may further include transmitting, by the IPTV provider server system, the stream of the primary media content to the IPTV client application. The method may further include determining, by the IPTV provider server system, that a viewer associated with the user account is interested in the common interest based on a viewing history of the user account. The method may further include inserting, by the IPTV provider server system, the affinity content into the stream during a portion of the at least one advertising break in response to determining that the viewer is interested in the common interest.

The method may further include receiving viewership data for a program indicating that the plurality of viewers streamed the program. The method may further include identifying the common interest shared by the plurality of viewers from metadata about the program. In some embodiments, determining that the viewer associated with the user account is interested in the common interest comprises: receiving the viewing history of the user account, wherein the viewing history identifies one or more programs streamed by the user account; and determining that at least one program of the one or more programs is related to the common interest based on metadata about the at least one program.

In some embodiments, the affinity content comprises one or more digital images related to the common interest. In some embodiments, generating the one or more digital images comprises: executing a generative Artificial Intelligence (GenAI) model on an identifier of the common interest to produce the one or more digital images; and storing the one or more digital images in a datastore in association with the identifier of the common interest. In some embodiments, the GenAI model is further executed on current information about the common interest, and the one or more digital images depict the current information. In some embodiments, generating the one or more digital images comprises: determining that a program provided by the IPTV provider server system is related to the common interest; capturing an image from the program; and generating the one or more digital images based on the image from the program.

The method may further include receiving the viewing history of the user account, wherein the viewing history identifies a program recently viewed by the viewer; and determining that the program is related to the common interest, indicating that the viewer is currently interested in the common interest. In some embodiments, inserting the affinity content into the stream is in further response to determining that the viewer is currently interested in the common interest.

In some embodiments, the primary media content comprises content from a broadcast television channel. In some embodiments, the primary media content comprises a recording of content from a broadcast television channel. In some embodiments, the primary media content comprises original video content that has been modified to include the at least one advertising break. In some embodiments, inserting the affinity content into the stream is in further response to determining that the at least one advertising break will not be filled by advertising content.

In some embodiments, a personalized advertising break content generation and delivery system is provided. The personalized advertising break content generation and delivery system may include one or more processors and a computer-readable storage media storing computer-executable instructions that, when executed by the one or more processors, cause the personalized advertising break content generation and delivery system to receive a common interest shared by a plurality of viewers. The instructions may further cause the personalized advertising break content generation and delivery system to generate affinity content related to the common interest. The instructions may further cause the personalized advertising break content generation and delivery system to receive a request from an IPTV client application for a stream of primary media content, wherein the stream will include at least one advertising break in the primary media content, and wherein the request is associated with a user account. The instructions may further cause the personalized advertising break content generation and delivery system to transmit the stream of the primary media content to the IPTV client application. The instructions may further cause the personalized advertising break content generation and delivery system to determine that a viewer associated with the user account is interested in the common interest based on a viewing history of the user account. The instructions may further cause the personalized advertising break content generation and delivery system to insert the affinity content into the stream during a portion of the at least one advertising break in response to determining that the viewer is interested in the common interest.

In some embodiments, one or more non-transitory computer-readable storage media are provided. The one or more non-transitory computer-readable storage media may store one or more instructions which, when executed by one or more processors of an Internet Protocol Television (IPTV) provider server system, cause the one or more processors to receive a common interest shared by a plurality of viewers. The one or more processors may be further caused to generate affinity content related to the common interest. The one or more processors may be further caused to receive a request from an IPTV client application for a stream of primary media content, wherein the stream will include at least one advertising break in the primary media content, and wherein the request is associated with a user account. The one or more processors may be further caused to transmit the stream of the primary media content to the IPTV client application. The one or more processors may be further caused to determine that a viewer associated with the user account is interested in the common interest based on a viewing history of the user account. The one or more processors may be further caused to insert the affinity content into the stream during a portion of the at least one advertising break in response to determining that the viewer is interested in the common interest.

### BRIEF DESCRIPTION OF THE DRAWINGS

FIG. 1 illustrates an embodiment of a personalized advertising break content generation and delivery system, according to some embodiments.

FIG. 2 illustrates an exemplary system architecture of a personalized advertising break content generation and delivery system, according to some embodiments.

FIG. 3 illustrates an exemplary data flow for providing personalized affinity content for presentation to users during intermissions in primary media content, according to some embodiments.

FIG. 4 illustrates an exemplary display of personalized affinity content, according to some embodiments.

FIG. 5 illustrates a method of personalizing advertising break content, according to some embodiments.

FIG. 6 illustrates another method of personalizing advertising break content, according to some embodiments.

### DETAILED DESCRIPTION OF THE INVENTION

Video, audio, and other media content can be delivered by an ever increasing number of providers, on virtually any device with a screen or speaker, via any one or a combination of terrestrial and extraterrestrial communications networks, to almost anywhere in the world. Often, the distribution of this media content can be partially or fully subsidized by advertising revenues, where advertisers pay content providers to include commercials or promotional content within predefined or preschedule breaks in the media streams. However, in some cases, content providers do not have enough advertising inventory to fill all of the breaks in the media streams, which can result in unused or underutilized advertising-breaks. To address this issue, content providers may leave the remaining time empty or fill it with generic content, which can cause potential loss of viewer engagement and satisfaction.

Embodiments according to the present disclosure can address these and other challenges with systems and methods for personalized advertising-break content generation and delivery. Based on viewership data across a population of viewers, content providers may generate new content tailored to common interests shared by various groups of viewers. Similarly, content providers may use individual viewership data to determine which common interests are shared by each particular viewer, as well as which of those interests are most relevant to the viewer at a given point in time. Subsequently, as a viewer is consuming the primary media content, content generated for a common interest shared by the viewer, and/or most relevant to the viewer at that point in time, can be used to fill any remaining time in the advertising breaks that may be left over from the available advertising content.

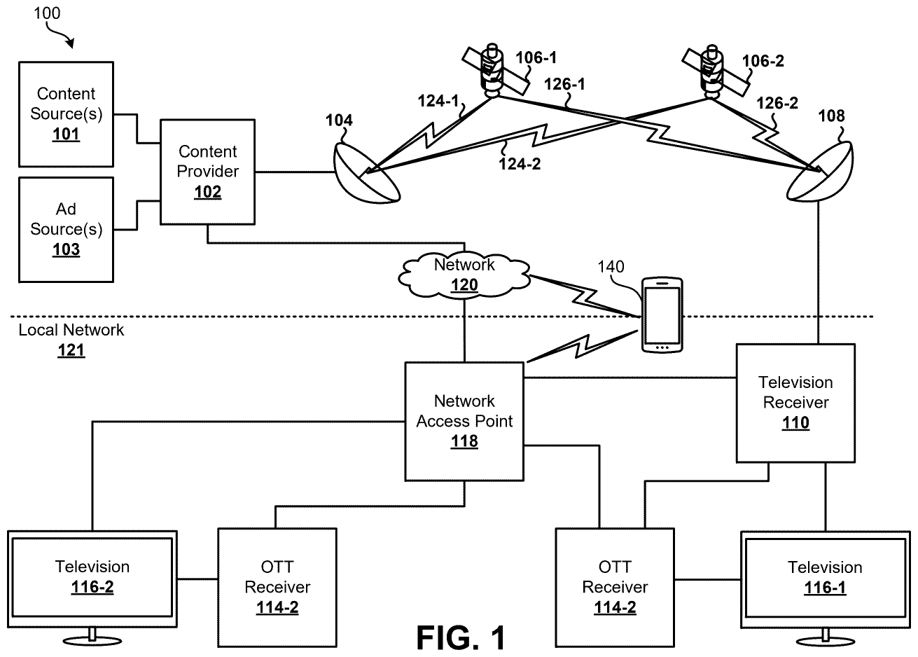

Further detail regarding personalized advertising-break content generation and delivery is provided in relation to the figures. FIG. 1 illustrates an embodiment of a personalized advertising break content generation and delivery system. For brevity, system 100 is depicted in a simplified and conceptual form and may generally include more or fewer systems, devices, networks, and/or other components as desired. Further, the number and type of features or elements incorporated within system 100 may or may not be implementation-specific, and at least some of the aspects of system 100 may be similar to a cable television distribution system, an IPTV (Internet Protocol Television) content distribution system, and/or any other type of media or content distribution system.

System 100 may include at least one network 120 that may facilitate bi-directional communication for data transfer between devices connected to network access point 118 and content provider 102. Additionally, or alternatively, network 120 may facilitate bi-directional communication for data transfer between content source(s) 101, content provider 102, and advertising source(s) 103. Network 120 is intended to represent any number of terrestrial and/or non-terrestrial network features or elements. For example, network 120 may incorporate or exhibit any number of features or elements of various wireless and/or hardwired packet-based communication networks such as, for example, a WAN (Wide Area Network) network, a HAN (Home Area Network) network, a LAN (Local Area Network) network, a WLAN (Wireless Local Area Network) network, the Internet, a cellular network, or any other type of communication network within which data may be transferred between and among respective components of the system 100.

System 100 may also include at least one local network 121 that establishes a bi-directional communication path for data transfer between and among television receiver 110, network access point 118, OTT receivers 114, televisions 116, mobile device 140, and/or one or more personal or business computing devices, such as local media servers, personal computers, or the like. Local network 121 may correspond to a home or business computing environment. Television receiver 110, together with OTT receivers 114 and televisions 116, may each be incorporated within or form at least a portion of a particular home or business computing network.

Television receiver 110 and OTT receivers 114 may correspond to television receivers and/or television converters, such as a set-top box (STB) for example, or smart TV content receivers. In another example, television receiver 110 and OTT receivers 114 may exhibit functionality integrated as part of or into a television; a DVR (Digital Video Recorder); a computer, such as a tablet computing device; or other computing systems or devices, as well as variations thereof. Further, television receiver 110 may be able to communicate with other devices in accordance with various communication protocol(s) and/or standard(s) including, for example, TCP/IP (Transmission Control Protocol/Internet Protocol), DLNA/DTCP-IP (Digital Living Network Alliance/Digital Transmission Copy Protection over Internet Protocol), HDMI/HDCP (High-Definition Multimedia Interface/High-bandwidth Digital Content Protection). For example, as disclosed further herein, one or more of the various elements or components of the at least one local network 121 may communicate using TCP/IP using one or more wireless techniques, such as Wi-Fi; or wired techniques, such as Ethernet or MoCA® (Multimedia over Coax Alliance). Still other embodiments are possible.

In practice, satellites 106 may each receive uplink signals 124 from satellite uplink 104. In this example, each of uplink signals 124 may contain one or more transponder streams of particular data or content, such as audiovisual content from one or more television channels, as supplied by content provider 102. For example, each of the respective uplink signals 124 may contain various media content from content source(s) 101 and/or advertising source(s) 103, such as encoded High Definition (HD) television channels, Standard Definition (SD) television channels, regional broadcast channels, on-demand programming, programming information, television commercials, movie trailers, promotional images, and/or any other content in the form of at least one transponder stream, in accordance with an allotted carrier frequency and bandwidth. In this example, different media content may be carried using different versions of satellites 106.

Satellites 106 may further relay uplink signals 124 to satellite dish 108 as downlink signals 126. Similar to uplink signals 124, each of downlink signals 126 may contain one or more transponder streams of particular data or content, such as various encoded and/or at least partially electronically scrambled television channels and/or on-demand content, in accordance with an allotted carrier frequency and bandwidth. Downlink signals 126, however, may not necessarily contain the same or similar content as a corresponding one of uplink signals 124. For example, uplink signal 124-1 may include a first transponder stream containing at least a first group or grouping of television channels, and downlink signal 126-1 may include a second transponder stream containing at least a second, different group or grouping of television channels. In other examples, the first and second group of television channels may have one or more television channels in common. In sum, there may be varying degrees of correlation between uplink signals 124 and downlink signals 126, both in terms of content and underlying characteristics. Further, satellite television signals may be different from broadcast television or other types of signals. Satellite signals may include multiplexed, packetized, and modulated digital signals. Once multiplexed, packetized and modulated, one analog satellite transmission may carry digital data representing several television stations or service providers. Some examples of service providers include HBO®, CBS®, and/or ESPN®.

Satellite dish 108 may be provided to receive television channels (e.g., on a subscription basis) provided by content source(s) 101 and/or content provider 102, satellite uplink 104, and/or satellites 106. For example, satellite dish 108 may receive particular transponder streams, or downlink signals 126, from one or more of satellites 106. As another example, satellite dish 108 may provide a plurality of television channel frequencies to a television frequency tuner of television receiver 110. Additionally, television receiver 110, which is communicatively coupled to satellite dish 108, may subsequently select via a tuner, decode, and relay particular transponder streams to television 116-1 for display thereon. For example, satellite dish 108 and television receiver 110 may, respectively, receive, decode, and relay at least one television channel to television 116-1. As another example, television receiver 110 may tune a television frequency tuner to a television channel frequency of a plurality of television channel frequencies received by satellite dish 108.

Programming or content associated with a channel may generally be presented live, or from a recording as previously stored on, by, or at television receiver 110. Here, the channel may be output to television 116-1 in accordance with the HDMI/HDCP content protection technologies. However, other embodiments are possible. For example, the channel may be output to television 116-1 in accordance with the MoCA® (Multimedia over Coax Alliance) home entertainment networking standard. As another example, the channel may be output to television 116-1 in accordance with the Transmission Control Protocol (TCP) and/or Internet Protocol (IP) via network access point 118 over local network 121. In yet another example, the channel may be output to television 116-1 via a wired network connection over a private network containing television 116-1 and television receiver 110.

Further, television receiver 110 may select via a tuner, decode, and relay particular transponder streams to one or both of OTT receivers 114 which may in turn relay particular transponder streams to a corresponding television of televisions 116 for display thereon. For example, satellite dish 108 and television receiver 110 may, respectively, receive, decode, and relay at least one television channel to television 116-1 by way of OTT receiver 114-1. Additionally, or alternatively, television receiver 110 may select via a tuner, decode, and relay particular transponder streams directly to televisions 116, personal computer 150, and/or mobile device 140 for display thereon. Similar to the above-example, television channels may be presented live, or from a recording as previously stored on television receiver 110, and may be output to television 116-1 by way of OTT television receiver 114-1 in accordance with a particular content protection technology and/or networking standard.

Relaying transponder streams and/or digital content from television receiver 110 to televisions 116 via OTT receivers 114 may include transmission via wireless communication. For example, the at least one local network 121 may include a private content network. Television receiver 110 may then transmit digital content to OTT receivers 114 via the private content network. Additionally, or alternatively, relaying transponder streams and/or digital content from television receiver 110 to televisions 116 via OTT receivers 114 may include transmission via one or more wired connections. For example, television receiver 110 may be connected to OTT receivers 114 and/or televisions 116 via a networking cable, such as CAT-5, a coaxial cable, a universal serial bus (USB) cable, and the like.

In some embodiments, OTT receivers 114, televisions 116, personal computer 150, and/or mobile device 140 execute a client software application that includes a user interface for integrating live television content from television receiver 110 with the media content provided by content source(s) 101, content provider 102, and/or advertising source(s) 103. In some embodiments, the client functionality is provided by a website and is accessible by OTT receivers 114, televisions 116, personal computer 150, and/or mobile device 140 via a web browser. When any of the devices wish to connect to a stream of television receiver 110 using the client application or via a web browser interface, it may specify an IP address associated with television receiver 110 to access and pull the media stream from television receiver 110. This action sends a request to television receiver 110, and the request travels across local network 121 and/or network 120 (e.g., the public Internet) to television receiver 110.

OTT receivers 114, televisions 116, mobile device 140, and/or personal computer 150 may receive digital content from content source(s) 101 and/or content provider 102 via network 120. For example, while television receiver 110 may receive satellite television channels via satellite dish 108 and provide them to OTT receivers 114, OTT receivers 114 and/or television receiver 110 may also access network 120 via network access point 118, as described below, to stream digital content from content provider 102 and/or one or more OTT provider(s) directly, or via content provider 102, such as Netflix®, Spotify®, Google®, YouTube®, Disney®, Hulu®, Peacock®, etc. and relay the digital content to televisions 116 for display thereon.

As described herein, the primary content of a television channel and/or digital content stream may include one or more intermissions or advertising breaks. For example, the primary content may include a live broadcast or stream of a television channel including one or more intermissions or breaks between segments or scenes of a television show, movie, or other program. As another example, the primary content may include recordings of a television show, movie, or other program with intermissions programmed to occur at predefined points during on-demand viewing.

The one or more intermissions or advertising breaks may be pre-scheduled by content source(s) 101 and/or content provider 102. For example, the content of a television show, movie, or other pre-recorded program from content source(s) 101 may identify one or more points-in-time within the content that correspond to the end of a scene or other segment. As another example, live streams of content from content source(s) 101 include signals or other indicators which, when received by content provider 102 for distribution, indicate that there is a break in the underlying content being received from content source(s) 101.

The length of the intermissions or advertising breaks may be defined by content source(s) 101 and/or content provider 102. For example, the length of pre-scheduled intermissions in a broadcast or stream of a television channel may be selected by content source(s) 101 so that the duration of the content plus the lengths of the intermissions fits within a programming block, such as a half-hour or hour-long programming block. As another example, the length of intermissions in pre-recorded and/or on-demand content may be selected by content provider 102 so that the overall length corresponds with that of a live programming block duration. Additionally, or alternatively, the length of the intermissions may be selected based on the availability of advertising content, such as commercials from advertising source(s) 103, or other promotional content that can be presented during the intermissions.

Advertising source(s) 103 may include entities such as advertising agencies, marketing firms, and brand advertisers that provide commercials and other promotional content to content provider 102 for insertion into the one or more intermissions or advertising breaks within broadcast, streaming content, and/or on-demand content. Additionally, or alternatively, advertising sources may include digital ad networks, content creators, social media influencers, and programmatic advertising platforms.

Content provider 102 may insert the commercials and other promotional content into the one or more intermissions in broadcast and/or streaming content before transmission from content provider 102. For example, content provider 102 may insert commercials from advertising source(s) 103 within intermissions in primary content from content source(s) 101 prior to their transmission via satellite uplink 104 and/or network 120.

Additionally, or alternatively, content provider 102 may transmit commercials and/or other promotional content separately from the primary content for subsequent insertion by media playback devices. For example, content provider 102 may transmit a collection of commercials and/or other promotional content to television receiver 110, OTT receivers 114, mobile device 140, and/or televisions 116 via satellite uplink 104 and/or network 120. Television receiver 110, OTT receiver 114, mobile device 140, and/or televisions 116 may store the commercial content and/or other promotional content in a local memory. Subsequently, an application or process executing on television receiver 110, OTT receivers 114, mobile device 140, and/or televisions 116 may select and present the commercial and/or other promotional content from the local memory during the one or more intermissions in the broadcast, streaming, or pre-recorded primary content.

In some embodiments, OTT receivers 114, televisions 116, mobile device 140, and/or television receiver 110 may collect usage and/or user data. As described herein, usage data may include information identifying content provided to a user, such as media content titles, preferred genres, or the like. For example, OTT receivers 114, televisions 116, mobile device 140, and/or television receiver 110 may collect, store, and/or analyze metadata about content consumed by a user via such devices to identify trends in content consumption, current and/or recent content interests, or the like. Usage and/or user data may further include identifying characteristics and/or demographic information about a user, such as the user's age, preferred languages, language proficiencies, preferred regional language, or the like.

In some embodiments, OTT receivers 114, televisions 116, mobile device 140, and/or television receiver 110 generate and transmit usage and/or user data to content provider 102 for analysis in accordance with the user's preferences and/or permissions. Additionally, or alternatively, content provider 102 may collect usage and/or user data from content streamed via network 120 to OTT receivers 114, televisions 116, mobile device 140, and/or television receiver 110.

As described above, usage and/or user data may be analyzed to determine one or more topics or interests that are relevant to a user and/or a group of users. As described herein, a topic or interest may include categories such as entertainment preferences (e.g., favorite TV shows or movie genres), hobbies and activities (e.g., sports, gardening, cooking), lifestyle choices (e.g., fitness, travel, fashion), current events (e.g., news, politics, local happenings), and demographic information (e.g., age group, location).

Based on historical and/or live content consumption by a user, a context may be determined for the user. A context for a user may include a hierarchical ranking of topics for which the user is historically and/or currently interested in consuming related content. For example, usage data indicating that a user routinely consumes content related to sports, a particular sport, and/or a particular sports team may be used to determine that, at any given time, the user is likely to be interested in consuming content associated with sports in general, the particular sport, and/or the particular team. As another example, live usage data indicating that a user is consuming content related to traveling, or a particular travel destination, may be used to determine that the user is currently most interested in content related to traveling or the particular destination.

The context for a user may be used to tailor content and/or advertising to better align with the current interests of the user, enhancing their overall viewing experience and engagement. For example, content provider 102, OTT receivers 114, televisions 116, mobile device 140, and/or television receiver 110 may use the context for a user to suggest content, such as a television show, a movie, a sporting event, or the like that is related to the highest ranked topic in the user's context, for consumption by the user. As another example, content provider 102, OTT receivers 114, televisions 116, mobile device 140, and/or television receiver 110 may use the context for a user to select commercials and/or other promotional content that are most relevant to the current interests of the user for presentation during one or more intermissions in the primary content consumed by the user, as described further herein.

Network access point 118 may function similar to a wireless router. For example, network access point 118 may receive digital communication from television receiver 110 and route the digital communication to an intended recipient of OTT receivers 114, televisions 116, personal computer 150, and mobile device 140. Network access point 118 may receive the digital communication via a wired connection from television receiver 110, such as via an Ethernet or MoCA® connection. Network access point 118 may then transmit the digital communication to the appropriate recipient via a wireless communication standard, such as Wi-Fi, Bluetooth®, ZigBee®, or the like. Additionally, network access point 118 may receive wireless communication from any of OTT receivers 114, televisions 116, personal computer 150, and mobile device 140 and relay the communication to television receiver 110 via a wired or wireless connection. For example, OTT receiver 114-2 may transmit a request to television receiver 110 via network access point 118 for live television media content corresponding to one of the

### Transponder Streams.

As described further below, the at least one local network 121 may include one or more general networks or general purpose networks. General networks may function in a similar manner, or for a similar purpose, as home or business local area networks configured to provide network access to a wide array of electronic devices for general purpose computing, such as email, web-browsing, and the like. Network access point 118 may establish, or otherwise provide access to, the general network. For example, network access point 118 may be a wired or wireless router or switch device configured to receive and distribute data from and to various devices coupled with it and/or between other networks, such as network 120. After connecting to network access point 118, the various electronic devices may transmit and/or receive data via the general network. In some embodiments, a general network is defined as a network which a user explicitly authorizes devices to use for communication by providing a password and SSID, or other access credentials. In contrast, access to private networks, such as those described below, may be managed by a device such as television receiver 110, and users may be otherwise unable to directly provide access credentials to such a network.

As described above, primary media content may include audio-visual content, such as movies, television shows, publicly shared video content, or the like. As further described above, primary media content may be provided for consumption with one or more pre-scheduled and/or predefined intermissions or advertising breaks during which secondary media content may be presented. Secondary media content may include advertisements, commercials, infomercials, or other promotional video, audio, and/or images. One or more advertising sources, such as advertising source(s) 103, may provide secondary media content to content providers, such as content provider 102, for presentation during the intermissions in primary media content provided to consumers.

In some embodiments, content providers, such as content provider 102, are unable to fill an advertising break with enough commercials from advertising sources. This shortfall can occur for several reasons, including a lack of sufficient ad inventory, mismatched targeting criteria that result in fewer relevant ads, or a temporary slowdown in advertiser demand. When faced with such situations, the content provider may fill the remaining time in the advertising break with alternative content, such as generic or stock images, promotional material for the content provider, or the like. However, presenting generic content may result in reduced user engagement, a diminished viewing experience, and lower customer satisfaction. Accordingly, by personalizing the alternative content presented to each viewer based on the interests of the user, content providers can ensure continuous engagement, a seamless viewing experience, and increased customer satisfaction.

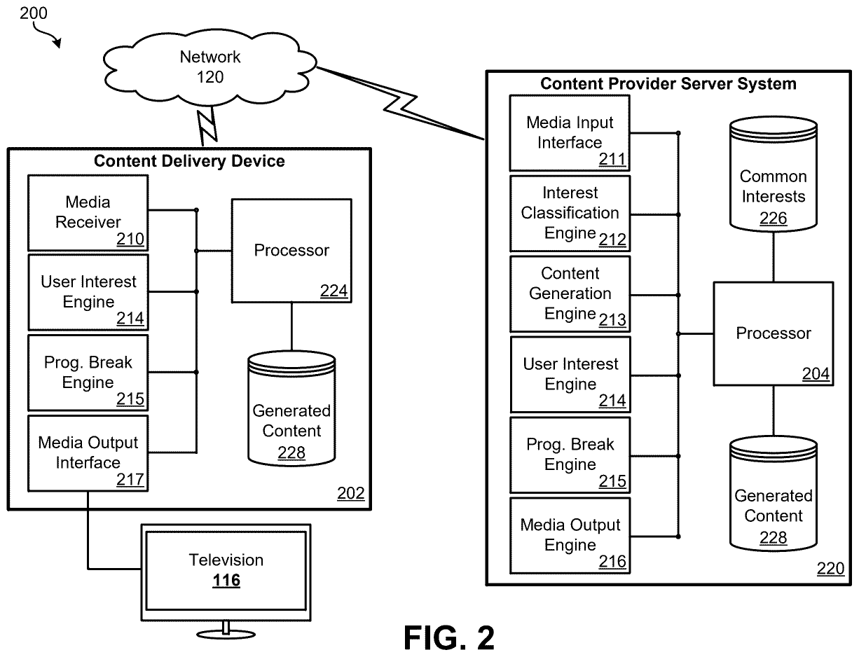

FIG. 2 illustrates an exemplary system architecture of a personalized advertising-break content generation and delivery system 200. System 200 may include one or more distributed devices and/or systems configured to provide personalized content for presentation to users during intermissions in primary media content. System 200 includes content provider server system 220 and content delivery device 202. System 200 also includes network 120 that may facilitate bi-directional communication between content provider server system 220 and content delivery device 202. In some embodiments, network 120 includes a satellite-based telecommunications network. Additionally, or alternatively, network 120 may include one or more general networks or general purpose networks, such as the Internet.

Content provider server system 220 may include one or more computer systems configured to provide primary and secondary media content to content delivery devices, such as content delivery device 202. Content provider server system 220 may include one or more software and/or hardware components, such as media input interface 211, interest classification engine 212, content generation engine 213, user interest engine 214, programming break engine 215, media output engine 216, processor 204, common interest datastore 226, and generated content datastore 228.

Content delivery device 202 may be a television or OTT receiver, such as television receiver 110 and OTT receivers 114 described above. Additionally, or alternatively, content delivery device 202 may be a personal computing device with one or more output interfaces, such as mobile device 140 as described above. For example, content delivery device 202 may be a laptop, a tablet, a smart display, a smart speaker, or other computing device capable of outputting visual and/or audio media content. Content delivery device 202 may be configured to receive primary and secondary media content from content provider server system 220 and/or one or more OTT services for presentation via one or more outputs, such as television 116, an integrated display and/or speaker, or the like.

Content delivery device 202 may include similar software and/or hardware components as content provider server system 220, such as user interest engine 214, programming break engine 215, and generated content datastore 228. Such components may provide the same or similar functionalities at different scales when implemented on content delivery device 202 as when implemented on content provider server system 220. Content delivery device 202 may further include media receiver 210 and media output interface 217.

Media input interface 211 may include one or more software and/or hardware components configured to receive and manage primary and secondary media content from one or more external content sources, such as broadcast television stations, streaming platforms, satellite feeds, and online media repositories. Media input interface 211 may provide seamless integration of diverse media formats, enabling content provider server system 220 to handle live broadcasts, pre-recorded content, and promotional materials like commercials and public service announcements. By utilizing advanced data processing algorithms and network communication protocols, media input interface 211 efficiently ingests and organizes incoming media, ensuring it is ready for distribution.

As described above, primary media content may include various forms of entertainment and information, such as pre-recorded movies, television shows, live broadcast content like news and sports events, documentaries, and other programming. Primary media content may be the main attraction for viewers as the core content offering within which secondary media content, such as commercials and promotional materials, is inserted. In some embodiments, media input interface 211 identifies one or more intermissions or advertising breaks pre-defined in the primary media content where secondary media content is to be inserted. For example, the digital data representing the primary media content may include one or more flags identifying specific timecodes or markers within the content where intermissions or breaks are scheduled to occur and optionally for how long they should occur. Additionally, or alternatively, media input interface 211 may analyze the primary media content to define one or more points within the primary media content when an intermission or advertising break will be inserted. For example, media input interface 211 may analyze the primary media content to identify natural pauses, scene transitions, or low-action sequences in the primary media content where an intermission could be inserted without disrupting the viewer's experience or continuity of the storyline.

Interest classification engine 212 may include one or more software and/or hardware components configured to identify common interests shared by groups of users based on their viewing habits, demographic information, and interaction with content. Common interests shared by groups of users may include preferred genres of movies and television shows, favorite sports teams or events, hobbies such as cooking or gardening, lifestyle preferences like fitness or travel, and engagement with specific types of news or current events.

Interest classification engine 212 may identify common interests shared by groups of users by analyzing metadata associated with primary media content received by media input interface 211, such as a genre associated with a movie or television show, actors or directors involved in a movie or television show, thematic elements, program descriptions, transcripts of dialogue contained in a program, or the like. Additionally, or alternatively, interest classification engine 212 may identify common interests shared by groups of users by analyzing aggregated data from various sources, such as viewership patterns, search histories, user feedback, or the like. In some embodiments, interest classification engine 212 identifies common interests from publicly available resources on the internet, such as news articles, social media posts, blogs, and forums. By integrating data from these diverse sources, interest classification engine 212 can identify topics of interest shared by groups of various sizes, as well as common trends and emerging interests.

Interest classification engine 212 may store common interests in common interests datastore 226. Common interests datastore 226 may include one or more database structures, such as relational databases, NoSQL databases, graph databases, or data warehouses. Each common interest identified by interest classification engine 212 may have one or more entries in common interests datastore 226 identifying the common interest and one or more details about the common interest, such as the specific user groups that share the interest, the frequency and duration of engagement with related content, associated demographic data, primary media content related to the common interest, and potential primary media content recommendations or advertisements that align with the interest.

Content generation engine 213 may include one or more software and/or hardware components configured to generate affinity content for presentation during one or more intermissions within primary media content. Affinity content may include images and/or audio representing recommendations for shows or movies, promotional offers, current events, or other subject matter related to common interests shared by viewers.

Content generation engine 213 may generate affinity content based on common interests shared by groups of users and/or viewers, as identified by interest classification engine 212 and/or as stored in common interests datastore 226. For example, content generation engine 213 may create tailored content segments that highlight upcoming or recent episodes of a TV series for a common interest that represents fans of the series. As another example, content generation engine 213 may create a recommendation for a new movie or show based on a common interest in the genre of the new movie or show, a common interest in an actor or director of the new movie or show, or the like. In yet another example, content generation engine 213 may generate custom graphics, images, and/or text depicting and/or describing travel tips, must-see attractions, and cultural insights related to a common interest in a particular travel destination. Similarly, content generation engine 213 may generate content showcasing popular recipes, cooking techniques, and food-related stories for a common interest in a specific cuisine, or provide tutorials, tips, and community highlights for a hobby such as photography, gardening, home-maintenance, or fitness. By leveraging the common interests of various groups of people, content generation engine 213 ensures that the affinity content is both engaging and pertinent, thereby enhancing the overall viewing experience during intermissions.

Content generation engine 213 may generate affinity content based on data for recent and current events. This data can come from a variety of sources, including search engines, social media trends, news articles, user interactions, and viewer feedback. For example, content generation engine 213 may generate custom graphics, images, and/or text depicting and/or describing breaking news updates, highlights from major sporting events, summaries of trending topics on social media, or the like. By leveraging real-time or current data, content generation engine 213 ensures that the affinity content remains relevant and engaging, reflecting the latest developments and interests of viewers.

Content generation engine 213 may use one or more generative AI models to create affinity content for a common interest, including Generative Adversarial Networks (GANs), Variational Autoencoders (VAEs), and Transformer models. In some embodiments, content generation engine 213 uses one or more commercially available generative AI solutions, such as: OpenAI's GPT-4® for text generation; Google Cloud Natural Language API® for sentiment analysis, entity recognition, and text generation; IBM Watson Natural Language Understanding® for keyword extraction, sentiment analysis, and text summarization; DALL-E® by OpenAI for generating images from textual descriptions; or the like. Such generative AI solutions may be integrated into content generation engine 213 through API calls and SDKs implemented in one or more software components of content generation engine 213.

The one or more generative AI models can be trained using diverse datasets, such as large corpora of text for language models, extensive labeled image collections for image generation, and video datasets for generating dynamic visual content. For example, a generative AI model that generates images that would be of interest to viewers who share a common interest could be trained on datasets containing thousands of labeled images related to that interest, such as photographs of popular travel destinations, artwork styles, or specific sports events. These datasets might include high-quality images from online repositories, social media platforms, and professional photography collections, ensuring a rich variety of examples to learn from. By exposing the models to a wide range of images within the chosen interest category, it can learn to generate visually appealing and contextually relevant images that resonate with the viewers'shared preferences.

To generate affinity content for a common interest, the one or more generative AI models can be provided with various types of data as inputs, including text prompts, viewing histories, images and/or clips from primary media content, descriptions and/or updates on current events, or the like. For example, to generate affinity content for a common interest in a particular movie or television genre, a generative AI model may be provided with detailed metadata about the genre, such as plot summaries, character descriptions, and thematic elements. Additionally, the model may receive input data including viewer engagement metrics, such as the frequency of views, likes, and shares of content within the genre, as well as relevant images and video clips from popular movies or TV shows in that genre. By leveraging this comprehensive set of input data, the generative AI model can create affinity content that aligns with the specific preferences and interests of viewers who enjoy that particular movie or television genre, such as custom video recommendations, interactive graphics, or themed promotional materials.

As another example, to generate affinity content for a common interest in sports, a particular team, and/or a particular player, the generative AI model may be provided with detailed statistics, player biographies, historical game footage, and recent match highlights. The model might also receive real-time updates on game scores, player performance metrics, and social media interactions related to the sport or team. By integrating these inputs, the generative AI model can produce tailored content such as game previews, player spotlights, interactive infographics, and highlight reels that cater to the specific interests of sports fans, thereby enhancing their engagement and viewing experience. Additional examples may include providing custom travel guides, top attractions, and cultural insights for a common interest in travel or a particular travel destination, providing real-time election updates, candidate profiles, and issue summaries for a common interest in a topic of public interest such as a political election or other matters of local and/or national concern.

Content generation engine 213 may generate affinity content on-demand and/or in response to specific triggers such as user interactions, changes in viewer behavior, breaking news updates, sporting event updates, or significant cultural events. For example, content generation engine 213 may generate affinity content for a common interest in response to a viewer's current and/or recent engagement with primary media content associated with the common interest, such as by generating recommendations for similar shows or movies as the viewer is currently or has recently watched. As another example, content generation engine 213 may generate affinity content in response to the current and/or recent results of a major sporting event, providing real-time updates, highlights, and commentary tailored to viewers who share a common interest in the sport, one of the teams involved in the event, a particular player, or the like. By responding to these dynamic triggers, content generation engine 213 ensures that the delivered content is both timely and highly relevant to the current interests and/or activities of a particular viewer, or a group of viewers who share a common interest. Additionally, or alternatively, content generation engine 213 may generate affinity content at predefined intervals. For example, content generation engine 213 may generate personalized media content once a week, every other day, daily, hourly, or the like.

Content generation engine 213 may store affinity content in generated content datastore 228. Generated content datastore 228 may include one or more data structures designed to store and manage multi-media content. For example, generated content datastore 228 may include: relational databases for indexing and querying video clips, images, and text based on their associated common interests; object storage systems for handling large files like high-resolution images and video segments; metadata repositories for maintaining detailed information about the affinity content, including its creation date, associated common interests, relevance scores, or the like.

User interest engine 214 may include one or more software and/or hardware components configured to determine and manage which common interests are relevant to a user or group of users. As described herein, the common interests that are relevant to a user or group of users, also referred to as a user context, represent the topics, subjects, genres or the like for which the user or group of users is most likely to interact with or be engaged by associated media content. As such, the user context may include a subset of the common interests identified by interest classification engine 212 that align closely with the viewing habits, demographic information, and interaction patterns of a user or group of users. For example, user interest engine 214 may identify relevant common interests based on factors such as the frequency and recency of engagement with certain types of media content, as well as explicit user preferences indicated through ratings, likes, and social media shares.

User interest engine 214 may identify common interests that are particularly relevant to an individual user or a group of users. For example, in the case of IPTV streaming, user interest engine 214 may identify common interests for each account member based on their individual viewing habits, search histories, and interaction with content, such as likes and shares. By analyzing these patterns, the engine can determine specific genres, shows, or topics that resonate most with each user. For instance, it might identify that one family member has a strong interest in cooking shows and documentaries, while another prefers action movies and sports events. Additionally, or alternatively, user interest engine 214 may identify common interests associated with a particular content delivery device based on the viewing habits, search histories, and interactions with content by the content delivery device, regardless of the individual user interacting with the content delivery device.

User interest engine 214 may determine which common interests are relevant to a user or group of users at a particular point in time and/or which common interests are relevant to the user or group of users more broadly. For example, as a user consumes primary media content, user interest engine 214 may determine that a common interest associated with the primary media content (e.g., as identified by interest classification engine 212 and/or as stored in common interests datastore 226) is relevant to the user and create an association between the user and the common interest. As the user consumes more primary media content associated with other common interests, user interest engine 214 may create new associations between the user and the other common interests.

In some embodiments, associations between the user and common interests are created in response to determining that the user has consumed a predefined threshold amount of primary media content associated with the common interest. For example, associations between a user and a common interest may be created after determining that the user has consumed multiple primary media content titles associated with the common interest (e.g., multiple episodes of a same show, multiple movies within a particular genre, etc); multiple hours of primary media content associated with the common interest; or another similar metric indicating that the user is not merely exploring a new interest.

User interest engine 214 may maintain a ranking of the common interests that are relevant to a user or group of users. For example, user interest engine 214 may monitor and/or maintain a record of the frequency with which a user consumes primary media content associated with each common interest relative to each other. Common interests associated with primary media content the user consumes more frequently may be ranked higher than common interests associated with primary media content that the user consumes less frequently. As described herein, the frequency with which a user consumes primary media content associated with a common interest may be defined in relation to the user's overall consumption times, per number of items consumed, or the like. For example, the frequency for a particular interest may be expressed as a percentage of the total time spent by the user consuming primary media content associated with any common interest.

User interest engine 214 may periodically review and revise the associations between a user and common interests and/or the individual user rankings associated with each common interest. For example, user interest engine 214 may analyze a user's media consumption history for the past week, past month, or another period of time, to determine if the frequencies with which the user consumes primary media content associated with each common interest has increased, remained the same, or decreased. In response to determining that the rate and/or frequency associated with a particular common interest has increased or decreased relative to other common interests, user interest engine 214 may update the rankings accordingly. In response to determining that the rate and/or frequency associated with a particular common interest has decreased below a predefined threshold, indicating that the interest is no longer relevant to the user, user interest engine 214 may remove the association between the user and the particular common interest.

User interest engine 214 may maintain a real-time ranking of the relevant common interests to a user based on current and/or recent media consumption by the user. For example, in response to an indication that a user is currently consuming content associated with a particular common interest, user interest engine 214 may determine that the particular common interest is most relevant to the user at that point in time, with other common interests being ranked lower based on the recency with which the user has consumed media content associated with those interests. Additionally, or alternatively, user interest engine 214 may evaluate extrinsic data about common interests to update the real-time ranking of common interests. This may be particularly helpful for common interests that are subject to frequent or periodic updates, such as sports, politics, news, current events, or the like.

Programming break engine 215 may include one or more software and/or hardware components configured to provide personalized affinity content (e.g., from generated content datastore 228) for presentation to users during intermissions in primary media content. Programming break engine 215 may select affinity content based on the common interests that are relevant to each user and/or group of users, as described above in relation to user interest engine 214. In other words, programming break engine 215 may select and provide different affinity content within the same primary media content from one user, or group of users, to the next. For example, given one or more common interests that are relevant to a particular user, programming break engine 215 may select affinity content generated for the one or more common interests by content generation engine 213 from generated content datastore 228.

In some embodiments, programming break engine 215 selects affinity content at random from the affinity content generated for each common interest that is relevant to a user. For example, given a list of common interests that are relevant to a user, programming break engine 215 may randomly select affinity content associated with any of the common interests in the list. Additionally, or alternatively, programming break engine 215 may randomly select a subset of the common interests that are relevant to a user before selecting affinity content associated with the subset. For example, programming break engine 215 may randomly select one common interest from the list of common interests that are relevant to a particular user, and proceed to select affinity content that has been generated for the one common interest.

In some embodiments, programming break engine 215 selects affinity content based on a ranking of the common interests that are relevant to a particular user or group of users. For example, programming break engine 215 may receive a ranked list of common interests for a user and select affinity content associated with the highest ranked interests. As described above in relation to user interest engine 214, the ranked list of common interests may be indicative of the common interests that the user is most often interested in and/or the common interests that the user is most likely to be interested in at that time.

While described herein as primarily selecting affinity content based on the context of a discrete or otherwise identifiable viewer or group of viewers, programming break engine 215 may additionally, or alternatively, select affinity content based on the primary media content within which the affinity content is to be presented. For example, programming break engine 215 may determine that the primary media content is related to one or more common interests and select affinity content corresponding to the one or more common interests in response. By selecting affinity content based on the primary media content within which it is to be presented, programming break engine 215 can effectively assume that, if a viewer is consuming primary media content related to a particular interest, the viewer is most likely to be interested in additional content related to the particular interest.

In some embodiments, programming break engine 215 selects affinity content based on the amount of time during an intermission in primary media content in which the affinity content is to be presented. For example, given a 1-minute portion of an intermission, programming break engine 215 may select the exact amount of affinity content to fill the allotted minute of the intermission. The exact amount of affinity content may be based on a combination of the amount of time to be filled and the total amount of time that will be consumed by each piece of affinity content. Additionally, or alternatively, programming break engine 215 may select a predefined amount of affinity content and provide it to one or more other components, such as media output engine 216, to determine how and/or what of the affinity content to present to the user.

Media output engine 216 may include one or more software and/or hardware components configured to deliver primary, secondary, and affinity content to content delivery devices, such as content delivery device 202, for presentation to a user and/or group of users. In some embodiments, media output engine 216 delivers the primary, secondary, and affinity content via one or more broadcast channels, streaming services, or on-demand delivery systems. For example, media output engine 216 may transmit primary, secondary, and affinity content to one or more satellite uplinks as part of a live broadcast. The live broadcast of the primary, secondary, and affinity content can then be received by a tuner controlled by content delivery device 202 tuned to the frequency associated with the live broadcast and presented on television 116 and/or stored in a memory of content delivery device 202. Additionally, or alternatively, media output engine 216 may transmit primary, secondary, and/or affinity content to one or more satellite uplinks as part of a background broadcast for on-demand content. As another example, media output engine 216 may transmit primary, secondary, and personalized affinity content to content delivery device 202 directly via one or more networks, such as network 120, in response to a request from content delivery device 202 for a live and/or on-demand stream containing the primary media content.

Turning to the components of content delivery device 202, media receiver 210 may include one or more software and/or hardware components configured to receive primary, secondary, and affinity content for consumption by a user. For example, in response to receiving a control input requesting a particular media content title, media receiver 210 may transmit a request via network 120 to content provider server system 220 for the requested media content. In response, media receiver 210 may receive the requested media content from content provider server system 220 via network 120. Additionally, or alternatively, media receiver 210 may include one or more hardware and/or firmware components, such as a tuner and a decoder, configured to receive RF signals from an antenna (e.g., satellite or over-the-air), or cable, interface, and convert them into a digital stream representing media content for a particular television channel, media title, radio station, or the like. In response to receiving a control input requesting a particular content channel, stream, or station, media receiver 210 may cause the tuner to tune to the requested channel and begin decoding the incoming media content.

In some embodiments, media receiver 210 receives the primary, secondary, and personalized affinity content from content provider server system 220 as a continuous stream of content. For example, in the case of IPTV, media receiver 210 may receive the primary media content with personalized affinity content already inserted into the intermissions. In this example, media receiver 210 may provide the received stream directly to media output interface 217 for output to the user.

Additionally, or alternatively, media receiver 210 may receive the primary, secondary, and/or affinity content as separate streams. For example, media receiver 210 may receive personalized affinity content via one or more background broadcasts and/or downloads. In this example, media receiver 210 may proceed to store the personalized affinity content in the instance of generated content datastore 228 implemented within content delivery device 202. Subsequently, the instance of programming break engine 215 implemented on content delivery device 202 can retrieve the personalized affinity content, as described further herein.

In the case of broadcast content distribution, affinity content may be received for all, or a subset of common interests, such as the most popular and/or most relevant common interests to all users/viewers. In the case of internet-based OTT solutions, such as IPTV, personalized affinity content may be downloaded for the common interests that are relevant to the user and/or group of users associated with content delivery device 202. By leveraging the ability to broadcast affinity content for insertion at the device level, broadcast networks can offer a more dynamic and interactive viewing experience, catering to diverse viewer preferences and interests. This method also allows for real-time updates and adjustments based on viewer data, ensuring that the affinity content remains timely and engaging. In the case of internet-based streaming solutions, the ability to download and cache personalized affinity content may further enhance the user experience by enabling seamless playback without buffering, even during network disruptions, and reduce bandwidth requirements by avoiding duplicative transmissions of the same content. This caching capability also ensures that personalized affinity content is readily available for insertion during intermissions, maintaining a consistent and high-quality viewing experience for users.

User interest engine 214 and/or programming break engine 215 may be implemented on content provider server system 220, content delivery device 202, or both. For example, user interest engine 214 may be implemented on content delivery device 202 in cases where content provider server system 220 may not have access to enough data about a user or group of users to determine the common interests that are relevant to the user or group of users, as may be the case in a satellite broadcast content distribution system where content delivery device 202 (e.g., a set-top box) is unable to communicate viewing history data back to content provider server system 220. As another example, programming break engine 215 may be implemented on delivery device 202 in cases where affinity content is transmitted separately from primary media content, as may be the case in a satellite broadcast content distribution system or in an IPTV distribution system that employs local personalization of affinity content by individual content delivery devices, such as content delivery device 202.

When implemented on content delivery device 202, user interest engine 214 and/or programming break engine 215 may perform the same or similar functions as when implemented on content provider server system 220. For example, user interest engine 214 may determine and manage which common interests are relevant to a user or group of users associated with content delivery device 202 based on media consumption by and/or other interactions with content delivery device 202. As another example, programming break engine 215 may use the common interests determined to be relevant to the user or group of users associated with content delivery device 202 to select personalized affinity content from generated content datastore 228 for presentation during intermissions within primary media content.

Media output interface 217 may include one or more hardware and/or software components configured to provide the primary, secondary, and personalized media content from media receiver 210, programming break engine 215, and/or generated content datastore 228 to a user for consumption. For example, media output interface 217 may include one or more hardware interfaces that enables the mixed media content to be produced by an external display, such as television 116, and/or a speaker. As another example, media output interface 217 may include one or more interfaces that enables media output interface 217 to transmit the modified media content to another process or device for conversion into a different format for display and/or reproduction.

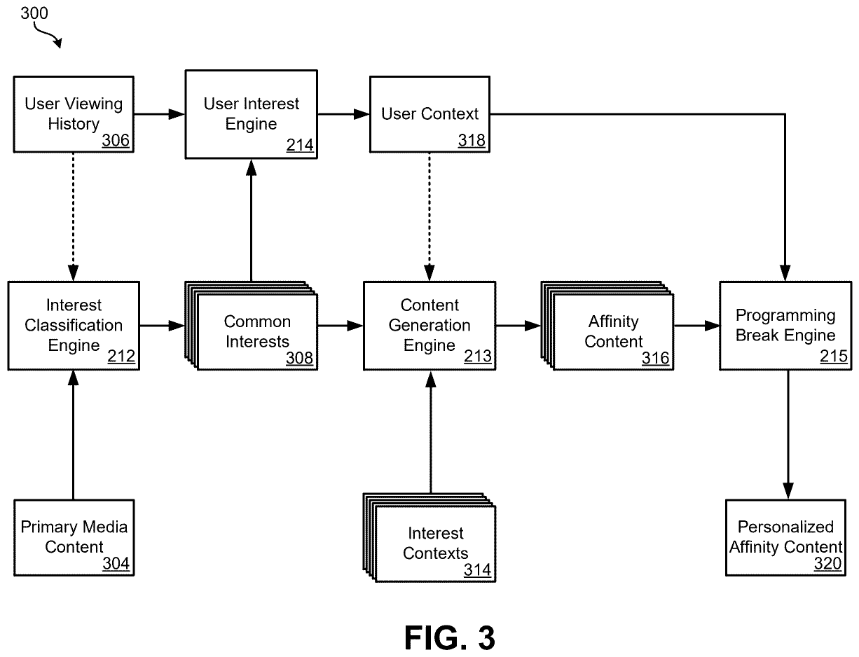

FIG. 3 illustrates an exemplary data flow 300 for providing personalized affinity content for presentation to users during intermissions in primary media content according to embodiments described herein. As illustrated, the process may be performed by one or more components of system 200 described above, such as interest classification engine 212, content generation engine 213, user interest engine 214, and programming break engine 215. As further illustrated, the process may begin with the generation of common interests 308 by interest classification engine 212 from primary media content 304. For example, and as described above, interest classification engine 212 may identify common interests 308 by analyzing metadata associated with primary media content, such as a genre associated with a movie or television show, actors or directors involved in a movie or television show, thematic elements, program descriptions, transcripts of dialogue contained in a program, or the like.

In some embodiments, interest classification engine 212 identifies common interests 308 shared by groups of users across a broad population of users/viewers. Additionally, or alternatively, interest classification engine 212 may identify common interests 308 for a single user or group of users based on their associated user viewing history 306. For example, by analyzing primary media content 304 identified in user viewing history 306 for a user, interest classification engine 212 can identify one or more common interests 308 for that particular user.

As further illustrated, user interest engine 214 may use user viewing history 306 and common interests 308 to determine user context 318. As described herein, user context 318 may represent a subset of common interests 308 that are particularly relevant to a user at a given point in time and/or more generally. For example, based on user viewing history 306 indicating that a user is currently viewing content associated with a first common interest, user context 318 may indicate that the user is currently most likely to be interested in content associated with the first common interest. As another example, based on user viewing history 306 for the past week, month, or similarly suitable length of time, user context 318 may identify a subset of common interests 308 corresponding to the most frequently consumed primary media content 304 by the user during that length of time as the interests that the user is most likely to be interested in at any time in the future.

Flow 300 may proceed with the generation of affinity content 316 by content generation engine 213 for common interests 308 using interest contexts 314. As described herein, affinity content 316 may include custom graphics, images, and/or text depicting and/or describing various aspects of a common interest. In some embodiments, content generation engine 213 generates affinity content 316 for each of common interests 308 shared by groups of users within the wider population of users. Additionally, or alternatively, content generation engine 213 may generate affinity content 316 specifically for a subset of common interests 308 that are most relevant to a particular user, as identified in user context 318 for the particular user.

As described herein, interest contexts 314 may include current and/or recent information related to corresponding subjects of common interests 308. For example, interest contexts 314 may include: breaking news updates for common interests related to a particular news story; highlights and/or updates from major sporting events for common interests in a particular sport or team; summaries of trending topics on social media; previews and/or other information about upcoming movie and/or television show releases for common interests in a related genre; or the like. In some embodiments, interest contexts 314 are provided to content generation engine 213 as part of a prompt from which affinity content 316 will be generated. Additionally, or alternatively, content generation engine 213 may obtain interest contexts 314 in response to receiving a request to generate affinity content for a particular common interest. For example, content generation engine 213 may query one or more resources, such as a public database, internet search engine, blogs, news sources, or the like for current information about a common interest.

Flow 300 may conclude with the selection and delivery of personalized affinity content 320 by programming break engine 215. As described above, programming break engine 215 may select and provide personalized affinity content 320 from affinity content 316 for each user and/or group of users associated with a content delivery device based on the common interests identified in their associated user context 318. For example, programming break engine 215 may select personalized affinity content 320 from affinity content 316 associated with one or more interests identified in user context 318 at random. As another example, programming break engine 215 may select personalized media content 320 from generated content 316 that correspond to the highest ranked interests in user context 318.

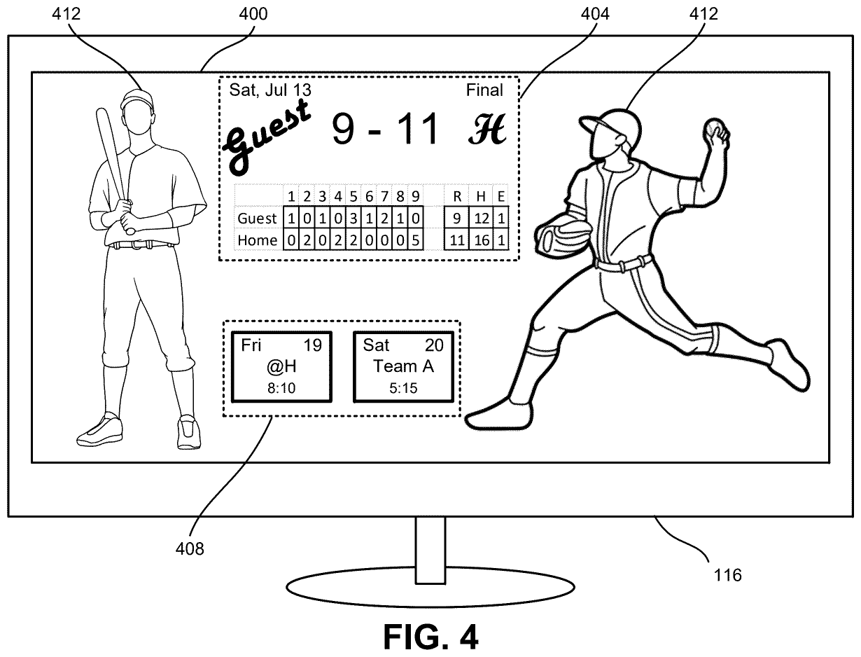

FIG. 4 illustrates an exemplary display of personalized affinity content 400 according to embodiments described herein. As illustrated, personalized affinity content 400 may be presented via television 116. In some embodiments, personalized affinity content 400 is provided by a component executing on television 116, and/or a content delivery device connected to television 116, such as programming break engine 215. For example, personalized affinity content 400 may be selected from a local cache of affinity content generated for a plurality of common interests for presentation during one or more intermissions in a live broadcast of primary media content received by a television receiver. Additionally, or alternatively, personalized affinity content 400 may be provided within a stream of primary media content from a web-service provider, such as content provider server system 220. For example, personalized affinity content 400 may be provided via a web-based application or browser executing on television 116, a connected content delivery device, and/or another computing device, such as mobile phone 140, a laptop or tablet computer, or the like.

As described above, affinity content may be created by one or more generative AI models for a common interest shared by a group of users and selected for presentation as personalized affinity content 400 based on an interest of a particular user or group of users associated with television 116 and/or a content delivery device connected to television 116. For example, and as illustrated, personalized affinity content 400 may be generated for a common interest in sports, or baseball more specifically. Further still, personalized media content 400 may be generated for a common interest in a particular team, such as the “Guest” team. Personalized affinity content 400 may then be selected for presentation within an intermission in primary media content based on determination that the viewer has an interest in sports, baseball, or the “Guest” team.

As further described above, affinity content may be generated based on current or up-to-date information about the common interest, images and/or clips from primary media content associated with the common interest, or the like. For example, and as illustrated, personalized affinity content 400 depicts results 404 from a recent baseball game involving the “Guest” team as well as schedule 408 of upcoming games involving the “Guest” team. As further illustrated, personalized affinity content 400 includes images 412 of players involved in the recent game or who play for one of the teams.

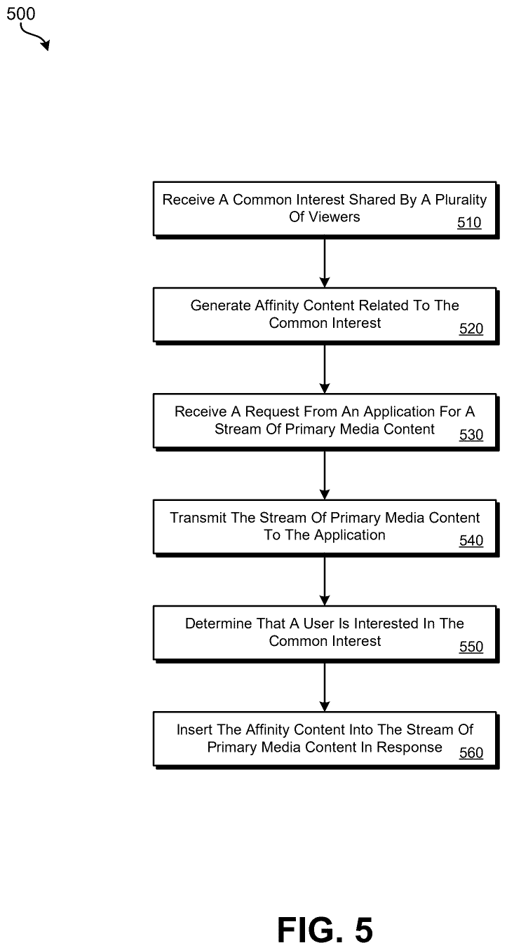

Various methods may be performed using the systems and devices detailed in relation to FIGS. 1-3. FIG. 5 illustrates an embodiment of a method 500 for personalizing advertising-break content. In some embodiments, one or more blocks of method 500 may be performed by components of system 100 and system 200, such as content delivery device 202 and/or content provider server system 220. For example, the components executing on provider server system 220 described above may perform some or all of the steps of method 500. Additionally, or alternatively, some of the steps of method 500 may be performed by components executing on content delivery device 202. In some embodiments, method 500 is utilized by content delivery and distribution systems that include bidirectional communication between the content distribution source and one or more content delivery or media playback devices, as is the case in an IPTV distribution system.

Method 500 may include, at block 510, receiving a common interest shared by a plurality of viewers. In some embodiments, the common interest is identified from commonalities in the viewing habits of the plurality of viewers. For example, the common interest may be identified from metadata for a program for which viewership data indicates that each of the plurality of viewers streamed the program. Additionally, or alternatively, the common interest may be identified from commonalities in media content received by and distributed from a content provider. For example, the common interest may be identified from matching and/or similar metadata for a plurality of programs distributed by a content provider. In some embodiments, method 500 may further include receiving and/or identifying a plurality of common interests shared by groups of viewers.

At block 520, affinity content related to the common interest is generated. The affinity content may include one or more digital images related to the common interest. In some embodiments, the affinity content depicts, illustrates, or otherwise includes current information about the common interest. In some embodiments, generating the affinity content includes executing a generative AI model on an identifier of the common interest. Additionally, or alternatively, the generative AI model may be executed on current information about the common interest. In some embodiments, generating the affinity content includes capturing images from programs related to the common interest and using the captured images to create the affinity content. In some embodiments, method 500 may further include generating affinity content for a plurality of common interests shared by corresponding groups of viewers.

At block 530, a request from an application for a stream of primary media content is received. The application may be an IPTV client application executing on a content delivery device, as described above. The primary media content may include at least one prescheduled intermission or advertising break. For example, the primary media content may include content from a broadcast television channel with one or more prescheduled commercial breaks. As another example, the primary media content may include a recording of the content from the broadcast television channel including the one or more prescheduled commercial breaks. In yet another example, the primary media content may include original video content, such as a movie or video, that has been modified to include one or more commercial breaks. The request may be associated with a user account maintained by a content provider server system. For example, the application may authenticate itself with the content provider server system using credentials associated with the user account and subsequently include the credentials, or an access token provided to the application upon authentication with the credentials, in the request for the primary media content.

At block 540, the stream of primary media content is transmitted to the application. The stream of primary media content may be transmitted via one or more networks, such as the Internet and one or more local area networks.

At block 550, a determination is made that a user is interested in the common interest. The user may be a user of the user account associated with the request received at block 530. Additionally, or alternatively, the user may be any user or group of users with access to the content delivery device. In some embodiments, the determination is based on a viewing history for the user account, as described above in relation to user interest engine 214. For example, the viewing history may identify one or more programs requested and/or streamed by an application associated with (e.g., authenticated using) the user account. Metadata for at least one program viewed by the user and associated with the common interest may be used to determine that the user is interested in the common interest, that the common interest is relevant to the user, and/or that the user is likely to engage with other content related to the common interest.

At block 560, the affinity content is inserted into the stream of primary media content. The affinity content may be inserted into the stream of primary media so that it is presented during a portion of at least one prescheduled intermission or advertising break in the primary media content. For example, the affinity content may be inserted during a portion of a commercial break for which available advertisements and/or other sponsored content is insufficient to fill the entire duration of the commercial break. The affinity content related to the common interest may be selected from a collection of affinity content related to a plurality of common interests in response to and/or based on the determination that the user is interested in the common interest. Additional affinity content related to other common interests is inserted into the stream of primary media content in response to and/or based on determinations that the user is also interested in the other common interests.

In some embodiments, the affinity content is inserted into the stream of the primary media content in further response to a determination that the user is currently interested in the common interest. For example, based on viewing history for the user account identifying a program related to the common interest that is currently being viewed by, or has recently been viewed by, a user associated with the user account, it may be determined that the user is currently interested in the common interest.

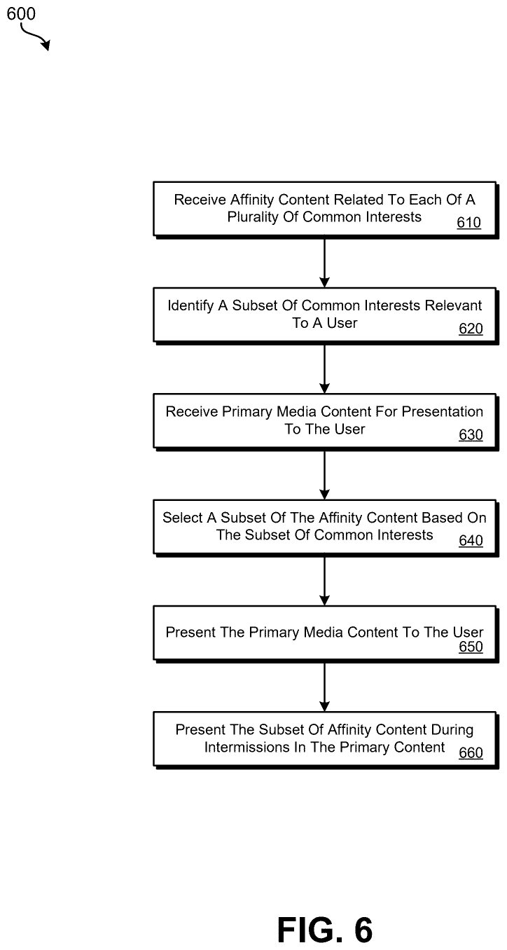

FIG. 6 illustrates an embodiment of a method 600 for personalizing advertising-break content. In some embodiments, one or more blocks of method 600 may be performed by components of system 100 and system 200, such as content delivery device 202 and/or content provider server system 220. For example, the components executing on content delivery device 202 described above may perform some or all of the steps of method 500. Additionally, or alternatively, some of the steps of method 600 may be performed by components executing on provider server system 220. In some embodiments, method 600 is utilized by broadcast content delivery and distribution systems, such as satellite and/or cable television providers.

Method 600 may include, at block 610, receiving affinity content related to each of a plurality of common interests. The affinity content may be received by a content delivery device as described above. The affinity content may be generated by and/or received from a content provider server system as further described above. The affinity content may be received via one or more networks. For example, the affinity content may be downloaded over the Internet in response to a request from an application executing on a content delivery device and/or in response to a push mechanism initiated by a content provider server system. As another example, the affinity content may be received via one or more transponder streams or downlink signals associated with background content caching from a satellite television provider. The affinity content may be saved in a local memory or datastore of a content delivery device in association with the common interests to which they relate.

The plurality of common interests may correspond to the most popular common interests across a population of viewers or users. For example, the plurality of common interests may include the top 10, 20, 30, or other similarly suitable number of common interests ranked by number of viewers or users who are interested in each common interest and/or based on the amount of primary media content related to each common interest. Additionally, or alternatively, the plurality of common interests may correspond to the set of common interests that are relevant to a particular user or group of users associated with a content delivery device and/or user account.

At block 620, a subset of the common interests that are relevant to a user are identified. The user may be one or more users associated with and/or otherwise having access to a content delivery device or user account. The subset of the common interests may be identified based on a viewing history for the user, user account, and/or content delivery device, as described above. The subset may include any of the plurality of common interests in which the viewing history indicates that the user is or has been interested. Additionally, or alternatively, the subset may include the common interests that are most relevant to the user's current context. The common interests that are most relevant to the user's current context may include one or more common interests that correspond to primary media content that the user is currently consuming or has consumed most recently. For example, given a user context indicating that the user is currently watching content corresponding to a common interest in baseball, the subset may include common interests in other sports, a particular baseball team, fitness, or the like.

At block 630, primary media content is received for presentation to the user. The primary media content may be received from a content provider server system. The primary media content may be received via the same or a different communication channel as the affinity content. For example, while the affinity content may be downloaded over the Internet, the primary media content may be received via a broadcast communication channel, such as a satellite stream. The primary media content may be received in response to transmitting a request to a content provider server system. Additionally, or alternatively, the primary media content may be received in response to a control input that causes a television frequency tuner to tune to a frequency specified by the control input. In some embodiments, the primary media content is received and stored by a background process for on-demand access, as may be the case with on-demand satellite content distribution.

At block 640, a subset of the affinity content is selected based on the subset of common interests that are relevant to the user. The subset of the affinity content may be selected at random from the affinity content that corresponds to the subset of common interests. As such, the selected subset of the affinity content may correspond to one or more common interests of the subset of common interests. In some embodiments, the subset of the affinity content is selected from a single common interest of the subset of common interests. The single common interest of the subset of common interests may be selected at random from the subset of common interests. In some embodiments, the subset of the affinity content is selected from the common interest of the subset of common interests that is most relevant to the user, as described above.

At block 650, the primary media content is presented to the user. The primary media content may be presented to the user in real or near-real-time as it is received, as may be the case when the primary media content corresponds to content from a live television channel. Additionally, or alternatively, the primary media content may be presented on-demand. The primary media content may be presented to the user via a display integrated within and/or connected to a content delivery device.

At block 660, the subset of the affinity content is presented to the user during intermissions in the primary media content. The subset of the affinity content may be inserted into a live stream of primary media content and/or the playback of recorded content so that it is presented during a portion of at least one prescheduled intermission or advertising break in the primary media content. The portion of the at least one prescheduled intermission may correspond to a portion of a live stream or recording that does not include primary media content, advertisements, and/or secondary content. This may be the case when, for example, a content provider does not have a sufficient amount of advertising or other paid content to fill the entire duration of one or more predefined commercial breaks in the primary media content.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method of personalizing advertising break content, comprising:
receiving, by an Internet Protocol Television (IPTV) provider server system, a common interest shared by a plurality of viewers;
generating, by the IPTV provider server system, affinity content related to the common interest;
receiving, by the IPTV provider server system, a request from an IPTV client application for a stream of primary media content, wherein the stream will include at least one advertising break in the primary media content, and wherein the request is associated with a user account maintained by the IPTV provider server system;
transmitting, by the IPTV provider server system, the stream of the primary media content to the IPTV client application;
determining, by the IPTV provider server system, that a viewer associated with the user account is interested in the common interest based on a viewing history of the user account; and
inserting, by the IPTV provider server system, the affinity content into the stream during a portion of the at least one advertising break in response to determining that the viewer is interested in the common interest.

2. The method of personalizing advertising break content of claim 1, further comprising:
receiving viewership data for a program indicating that the plurality of viewers streamed the program; and
identifying the common interest shared by the plurality of viewers from metadata about the program.

3. The method of personalizing advertising break content of claim 1, wherein determining that the viewer associated with the user account is interested in the common interest comprises:
receiving the viewing history of the user account, wherein the viewing history identifies one or more programs streamed by the user account; and
determining that at least one program of the one or more programs is related to the common interest based on metadata about the at least one program.

4. The method of personalizing advertising break content of claim 1, wherein the affinity content comprises one or more digital images related to the common interest.

5. The method of personalizing advertising break content of claim 4, wherein generating the one or more digital images comprises:
executing a generative Artificial Intelligence (GenAI) model on an identifier of the common interest to produce the one or more digital images; and
storing the one or more digital images in a datastore in association with the identifier of the common interest.

6. The method of personalizing advertising break content of claim 5, wherein the GenAI model is further executed on current information about the common interest, and the one or more digital images depict the current information.

7. The method of personalizing advertising break content of claim 4, wherein generating the one or more digital images comprises:
determining that a program provided by the IPTV provider server system is related to the common interest;
capturing an image from the program; and
generating the one or more digital images based on the image from the program.

8. The method of personalizing advertising break content of claim 1, further comprising:
receiving the viewing history of the user account, wherein the viewing history identifies a program recently viewed by the viewer; and
determining that the program is related to the common interest, indicating that the viewer is currently interested in the common interest;
wherein inserting the affinity content into the stream is in further response to determining that the viewer is currently interested in the common interest.

9. The method of personalizing advertising break content of claim 1, wherein the primary media content comprises content from a broadcast television channel.

10. The method of personalizing advertising break content of claim 1, wherein the primary media content comprises a recording of content from a broadcast television channel.

11. The method of personalizing advertising break content of claim 1, wherein the primary media content comprises original video content that has been modified to include the at least one advertising break.

12. The method of personalizing advertising break content of claim 1, wherein inserting the affinity content into the stream is in further response to determining that the at least one advertising break will not be filled by advertising content.

13. A personalized advertising break content generation and delivery system, comprising:
one or more processors; and
a computer-readable storage media storing computer-executable instructions that, when executed by the one or more processors, cause the personalized advertising break content generation and delivery system to:
receive a common interest shared by a plurality of viewers;
generate affinity content related to the common interest;
receive a request from an IPTV client application for a stream of primary media content, wherein the stream will include at least one advertising break in the primary media content, and wherein the request is associated with a user account;
transmit the stream of the primary media content to the IPTV client application;
determine that a viewer associated with the user account is interested in the common interest based on a viewing history of the user account; and
insert the affinity content into the stream during a portion of the at least one advertising break in response to determining that the viewer is interested in the common interest.

14. The personalized advertising break content generation and delivery system of claim 13, wherein the computer-executable instructions cause the personalized advertising break content generation and delivery system to determine that the viewer associated with the user account is interested in the common interest by:
receiving the viewing history of the user account, wherein the viewing history identifies one or more programs streamed by the user account; and
determining that at least one program of the one or more programs is related to the common interest based on metadata about the at least one program.

15. The personalized advertising break content generation and delivery system of claim 13, wherein:
the affinity content comprises one or more digital images related to the common interest; and
the computer-executable instructions further cause the personalized advertising break content generation and delivery system to:
execute a generative Artificial Intelligence (GenAI) model on an identifier of the common interest to produce the one or more digital images; and
store the one or more digital images in a datastore in association with the identifier of the common interest.

16. The personalized advertising break content generation and delivery system of claim 15, wherein the GenAI model is further executed on current information about the common interest, and the one or more digital images depict the current information.

17. One or more non-transitory computer-readable storage media storing one or more instructions which, when executed by one or more processors of an Internet Protocol Television (IPTV) provider server system, cause the one or more processors to:
receive a common interest shared by a plurality of viewers;
generate affinity content related to the common interest;
receive a request from an IPTV client application for a stream of primary media content, wherein the stream will include at least one advertising break in the primary media content, and wherein the request is associated with a user account;
transmit the stream of the primary media content to the IPTV client application;
determine that a viewer associated with the user account is interested in the common interest based on a viewing history of the user account; and
insert the affinity content into the stream during a portion of the at least one advertising break in response to determining that the viewer is interested in the common interest.

18. The one or more non-transitory computer-readable storage media of claim 17, wherein the one or more instructions further cause the one or more processors to:
receive the viewing history of the user account, wherein the viewing history identifies a program recently viewed by the viewer; and
determine that the program is related to the common interest, indicating that the viewer is currently interested in the common interest;
wherein inserting the affinity content into the stream is in further response to determining that the viewer is currently interested in the common interest.

19. The one or more non-transitory computer-readable storage media of claim 17, wherein the one or more instructions further cause the one or more processors to:
receive viewership data for a program indicating that the plurality of viewers streamed the program; and
identify the common interest shared by the plurality of viewers from metadata about the program.

20. The one or more non-transitory computer-readable storage media of claim 17, wherein:
the affinity content comprises one or more digital images related to the common interest; and
the one or more instructions further cause the one or more processors to:
execute a generative Artificial Intelligence (GenAI) model on an identifier of the common interest to produce the one or more digital images; and
store the one or more digital images in a datastore in association with the identifier of the common interest.
